(19) United States
(12) Patent Application Publication
(10) Pub. No.: US 2011/0158340 A1
(43) Pub. Date: Jun. 30, 2011

(54) VIRTUAL ANTENNA ARRAY FOR WIRELESS DEVICES

(75) Inventor: Craig R. Swanson, San Diego, CA (US)

(73) Assignee: QUALCOMM INCORPORATED, San Diego, CA (US)

(21) Appl. No.: 12/783,317

(22) Filed: May 19, 2010

Related U.S. Application Data
(60) Provisional application No. 61/290,423, filed on Dec. 28, 2009.

(51) Int. Cl. H04L 1/02

(52) U.S. Cl. 375/267

(57) ABSTRACT

A system for wireless communication is disclosed. The system includes a plurality of antenna nodes configured to receive an incoming signal, extract versions of an incoming packet from the incoming signal, and send the versions on a packet-based network. The system also includes a receive processing node configured to receive the versions of the incoming packet from the antenna nodes, determine if any of the versions are complete packets, and recover a complete version of the incoming packet based on the versions if none of the versions is complete. The system also includes a transmit processing node configured to transmit an outgoing packet on one or more of the antenna nodes based on quality feedback data.

### RELATED APPLICATIONS

This application is related to and claims priority from U.S. Provisional Patent Application Ser. No. 61/290,423, filed Dec. 28, 2009, entitled “VIRTUAL ANTENNA ARRAY FOR WIRELESS DEVICES” which is expressly incorporated by reference herein in its entirety.

### TECHNICAL FIELD

The present disclosure relates generally to communication systems. More specifically, the present disclosure relates to a virtual antenna array for wireless devices.

### BACKGROUND

A mobile station may communicate with one or more base stations via transmissions on the uplink and the downlink. The uplink (or reverse link) refers to the communication link from the mobile station to the base station, and the downlink (or forward link) refers to the communication link from the base station to the mobile station.

The resources of a wireless communication system (e.g., bandwidth and transmit power) may be shared among multiple mobile stations. A variety of multiple access techniques are known, including code division multiple access (CDMA), time division multiple access (TDMA), frequency division multiple access (FDMA), orthogonal frequency division multiple access (OFDMA), single-carrier frequency division multiple access (SC-FDMA), and so forth.

A mobile station may use a variety of systems and methods to communicate with other devices. Since a significant amount of processing resources and battery power are used to transmit and receive data in wireless devices, it may be desirable to make the transmission and reception mechanisms more efficient and cost-effective. Therefore, benefits may be realized by optimizing the systems and methods by which wireless devices send and receive data.

### BRIEF DESCRIPTION OF THE DRAWINGS

FIG. 1 shows an example of a wireless communication system in which the methods and apparatus disclosed herein may be utilized;

FIG. 2 is a block diagram of a system that includes a distributed base station;

FIG. 3 is a block diagram of a system implementing a distributed base station;

FIG. 4 is a block diagram illustrating a system with a mobile virtual antenna array;

FIG. 5 is a block diagram illustrating a distributed base station;

FIG. 6 is a flow diagram illustrating a method for receiving data using a distributed base station;

FIG. 7 illustrates means-plus-function blocks corresponding to the method of FIG. 6;

FIG. 8 is a flow diagram illustrating a method for transmitting data using a distributed base station;

FIG. 9 illustrates means-plus-function blocks corresponding to the method of FIG. 8; and

FIG. 10 illustrates certain components that may be included within a wireless device.

### DETAILED DESCRIPTION

A system for wireless communication is disclosed. The system includes a plurality of antenna nodes configured to receive an incoming signal, extract versions of an incoming packet from the incoming signal, and send the versions on a packet-based network. The system also includes a receive processing node configured to receive the versions of the incoming packet from the antenna nodes, determine if any of the versions are complete packets, and recover a complete version of the incoming packet based on the versions if none of the versions is complete. The system also includes a transmit processing node configured to transmit an outgoing packet on one or more of the antenna nodes based on quality feedback data.

The antenna nodes may be placed between ten and 100 meters apart from each other. The quality feedback data may indicate a quality of one or more wireless communication links between one or more of the antenna nodes and a mobile station. The transmit processing node may be further configured to transmit the outgoing packet using only a subset of the antenna nodes and not at least one of the antenna nodes. The receive processing node may be further configured to recover the complete version of the incoming packet using baseband correlation, summation, and decoding if none of the versions is complete. The packet-based network may be an internet protocol (IP) local area network (LAN). The receive processing node may be further configured to determine if any of the versions are complete by using a cyclic redundancy check (CRC), a checksum, or a parity bit.

A method for wireless communication is also disclosed. Versions of an incoming packet are extracted from a received incoming signal. The versions are sent to a receive processing node on a packet-based network. It is determined if any of the versions are complete packets. If none of the versions is complete, a complete version of the incoming packet is recovered based on the versions. An outgoing packet is transmitted on one or more of a plurality of antenna nodes based on quality feedback data.

A system for wireless communication is also disclosed. The system includes a means for extracting versions of an incoming packet from a received incoming signal. The system also includes means for sending the versions to a receive processing node on a packet-based network. The system also includes means for determining if any of the versions are complete packets. The system also includes means for recovering a complete version of the incoming packet based on the versions if none of the versions is complete. The system also includes means for transmitting an outgoing packet on one or more of a plurality of antenna nodes based on quality feedback data.

A computer-program product wireless communication is also disclosed. The computer-program product comprises a computer-readable medium having instructions thereon. The instructions include code for sending the versions to a receive processing node on a packet-based network. The instructions also include code for determining if any of the versions are complete packets. The instructions also include code for recovering a complete version of the incoming packet based on the versions if none of the versions is complete. The instructions also include code for transmitting an outgoing packet on one or more of a plurality of antenna nodes based on quality feedback data.

Wireless communication systems have become an important means by which many people worldwide communicate. A wireless communication system may provide communication for a number of mobile stations, each of which may be serviced by a base station. As used herein, the term “mobile station” refers to an electronic device that may be used for voice and/or data communication over a wireless communication system. Examples of mobile stations include cellular phones, personal digital assistants (PDAs), handheld devices, wireless modems, laptop computers, personal computers, etc. A mobile station may alternatively be referred to as an access terminal, a mobile terminal, a subscriber station, a remote station, a user terminal, a terminal, a subscriber unit, a mobile device, a wireless device, user equipment, or some other similar terminology. The term “base station” refers to a wireless communication station that is installed at a fixed location and used to communicate with mobile stations. A base station may alternatively be referred to as an access point, a Node B, an evolved Node B, or some other similar terminology.

Fast and slow fades and signal path obstacles may increase the difficulty of receiving and transmitting wireless radio frequency (RF) signals even more significantly at high data rates than at lower data rates. This negatively impacts system capacity because retransmissions may consume more bandwidth and higher power levels may be needed to ensure reliable communications, thus generating more interference. Furthermore, the architecture used in existing systems tends to rely upon each receiver/transmitter being built with high reliability and full power in mind, therefore making them more expensive than equipment built to lower reliability standards and lower power levels that achieve high reliability and high power by multiplicity of transmitters and receivers. The present systems and methods may be used to accomplish one or more of the following: (1) increase wireless data rates; (2) improve wireless signal quality/quality of service (QoS) while lowering overall power levels; (3) improve fault tolerance; (4) increase system capacity by reducing retransmissions and interference; (5) reduce infrastructure cost by allowing increased production of standardized receive/transmit modules that can be combined to cover a service area rather than using higher power amplifiers; and (6) reduce infrastructure hosting costs by allowing transmitter and receiver modules to be positioned in many locations cheaper than high-cost cellular towers and similar sites. In addition, the present systems and methods may be implemented in mobile devices to achieve similar results. The exact implementation for infrastructure and mobile devices may vary somewhat due to mobile limitations on power, personal area network (PAN) bandwidth, and spatial diversity that are not so tightly constrained for infrastructure applications.

The present systems and methods may use commoditized receive and transmit modules to build an array of receivers and transmitters that offer the above-mentioned improvements.

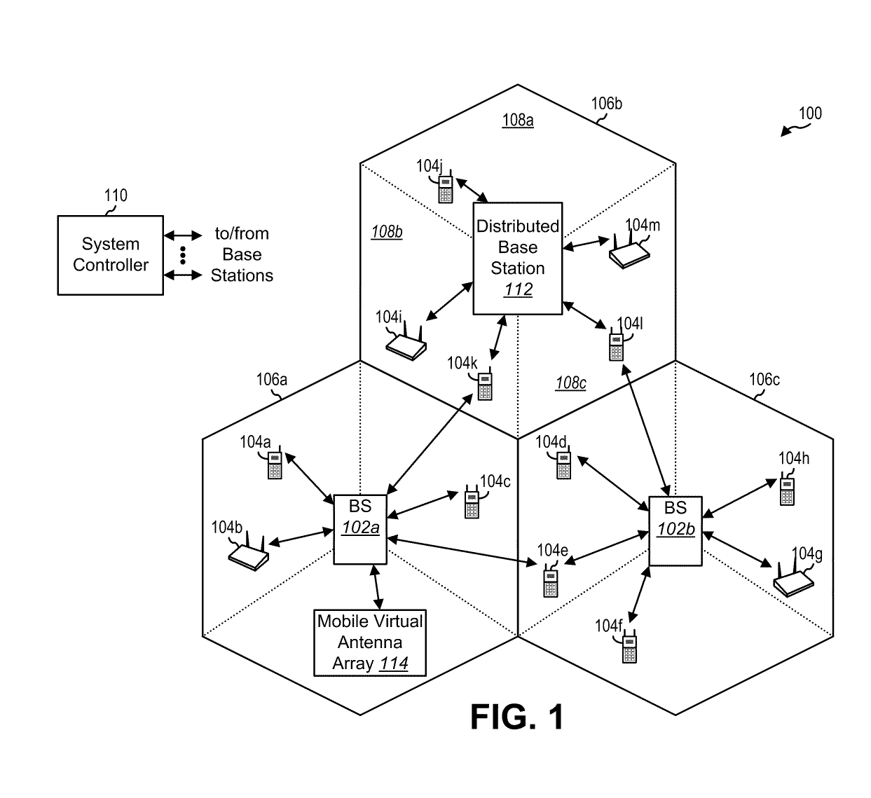

FIG. 1 shows an example of a wireless communication system 100 in which the methods and apparatus disclosed herein may be utilized. The wireless communication system 100 includes multiple base stations (BS) 102a-b and multiple mobile stations (MS) 104a-m. Each base station 102a-b provides communication coverage for a particular geographic area 106a-c. The term “cell” may refer to a base station 102a-b and/or its coverage area 106a-c depending on the context in which the term is used.

To improve system capacity, a base station coverage area 106a-c may be partitioned into multiple smaller areas, e.g., three smaller areas 108a, 108b, and 108c. Each smaller area 108a, 108b, 108c may be served by a respective base station.

Mobile stations 104a-m are typically dispersed throughout the system 100. A mobile station 104a-m may communicate with zero, one, or multiple base stations 102a-b on the downlink and/or uplink at any given moment.

For a centralized architecture, a system controller 110 may couple to the base stations 102a-b and provide coordination and control for the base stations 102a-b. The system controller 110 may be a single network entity or a collection of network entities. For a distributed architecture, base stations 102a-b may communicate with one another as needed.

Additionally, the system 100 may include one or more distributed base stations 112 that may include many small, cheap antenna nodes spaced relatively far apart, e.g., 10 to 100 meters. For example, the antenna nodes may be off-the-shelf components that are widely available. The term “small” may indicate an ability of each node to fit in a server rack, a closet, a personal computer (PC) case or fill a volume of less than a required volume, e.g., 1 ft³, 2 ft³, 3 ft³, 4 ft³, 5 ft³, etc. The term “cheap” may indicate a cost that is a certain threshold less than comparable nodes that do not operate at the packet-level, e.g., 10%, 20%, 30%, 40%, 50%, etc. Conventional base stations 102a-b may have a small number of large, co-located antennas. Therefore, if a mobile station 104a-m moves to an area with a line of sight obstruction, the obstruction is likely to affect transmission on all antennas used by the base station 102a-b. The distributed base station 112, however, introduces wide spatial diversity by using distantly spaced antenna nodes, e.g., 10 to 100 meters. As used herein, the term “distributed base station” refers to a base station with a virtual antenna array as described below. Thus, it is likely that even if a mobile station 104a-m is obstructed from one antenna node, the mobile station 104a-m will likely be able to communicate with one of the other antenna nodes. This may allow the mobile station 104a-m to use lower power when transmitting because it is more likely that one of the antenna nodes on the distributed base station 112 will receive a good signal. Similarly, the distributed base station 112 may use feedback data from the antenna nodes to selectively transmit on only the antenna nodes that are receiving high quality signals from the mobile station 104a-m, e.g., antenna nodes for which received packets pass a cyclic redundancy check (CRC). Since an antenna node that does not receive a high quality signal from a mobile station 104a-m is unlikely to transmit a signal to the mobile station 104a-m effectively, the distributed base station 112 may selectively transmit signals on a subset of antenna nodes, thereby creating less noise for neighboring communication links. The distributed base station 112 may be used in wireless communication systems 100 without any alteration of the mobile stations 104a-m.

The system 100 may also include one or more mobile virtual antenna arrays 114 that may include multiple antenna nodes spaced relatively far apart, e.g., 1 to 5 feet. For example, a person may have a first mobile station 104a-m in a coat pocket and a second mobile station 104a-m in a pants pocket that communicate with each other over a personal area network (PAN). The mobile stations 104a-m may each be capable of communicating with a base station 102a-b. However, if the first mobile station 104a-m is not receiving a good signal from the base station 102a-b, the second mobile station 104a-m may receive the signal and share the signal with the first mobile station 104a-m. Therefore, the two mobile stations 104a-m may form a mobile virtual antenna array 114 that shares receiving and transmitting resources.

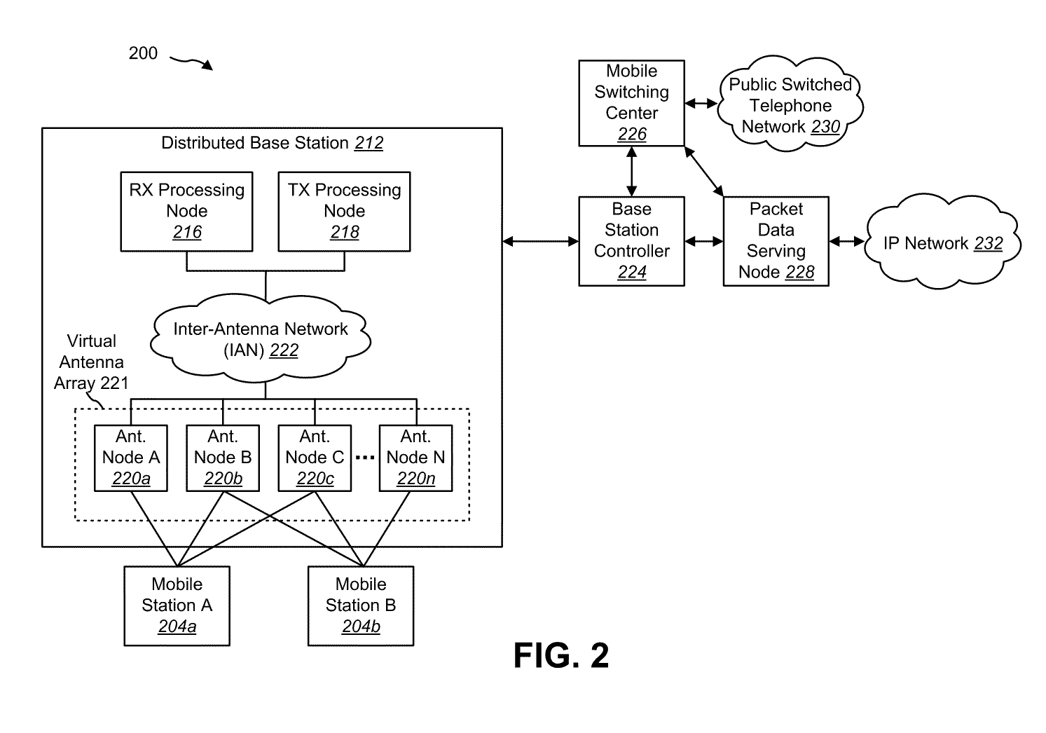

FIG. 2 is a block diagram of a system 200 that includes a distributed base station 212. The distributed base station 212 may include a receive (RX) processing node 216 and a transmit (TX) processing node 218 that may communicate with multiple antenna nodes 220 via an inter-antenna network (IAN) 222. There may be N antenna nodes 220 that are each capable of receiving signals from mobile stations 204 and transmitting signals to mobile stations 204. For example, mobile station A 204a may communicate with antenna node A 220a, antenna node B 220b, and antenna node C 220c while mobile station B 204b may communicate with antenna node B 220b, antenna node C 220c, and antenna node N 220n. Together, the antenna nodes 220 may form a virtual antenna array 221. Additionally, the antenna nodes 220 may be capable of signal processing, which allows the IAN 222 to be packet-based. In other words, each antenna node 220 may be capable of fully decoding received signals into packets and sharing the packets, or portions of the packets, with the RX processing node 216. Thus, the antenna nodes 220 may communicate on the packet level rather than the transmission signal level. This may reduce load on IAN 222 and focus processing power of the RX processing node 216 on the task of recovering packets that no individual antenna node 220 completely receives, e.g., the received packet does not pass a cyclic redundancy check.

The RX processing node 216 may receive and combine, when necessary, packets received at the antenna nodes 220 into final received data. There are at least two possible scenarios for receiving data at the distributed base station 212. First, at least one of the antenna nodes 220 successfully receives a packet, decodes it, determines that the packet is complete, (e.g., the packet passes a cyclic redundancy check (CRC)), and sends it to the RX processing node 216. In this case, the RX processing node 216 may send the packet to its destination. In a different scenario, no single antenna node 220 receives the complete packet, e.g., each received signal has bit errors as determined by a CRC. In this case, the RX processing node 216 may combine samples from incomplete packets from multiple antenna nodes 220 and attempt to recover the complete packet. This recovery may include baseband correlation, summation, and decoding.

The TX processing node 218 may use quality feedback data from the RX processing node 216 to selectively transmit signals using one or more antenna nodes 220. For example, since mobile station A 204a is not communicating with antenna node N 220n, the TX processing node 218 may send packets meant for mobile station A 204a to antenna node A 220a, antenna node B 220b, and antenna node C 220c for transmission, but not antenna node N 220n. By not transmitting using antenna node N 220n, the distributed base station 212 may minimize unwanted noise on the communication link with mobile station B 204b. Likewise, if mobile station B 204b is not communicating with antenna node A 220a, the TX processing node 218 may send packets meant for mobile station B 204b to antenna node B 220b, antenna node C 220c, and antenna node N 220N for transmission, but not antenna node A 220a. By not transmitting using antenna node A 220a, the distributed base station 212 may minimize unwanted noise on the communication link with mobile station A 204a.

The RX processing node 216 and TX processing node 218 may be mass-volume and commercial, although they may not have Network Equipment-Building System (NEBS) reliability. Furthermore, Gigabit Ethernet (GigE) may be used for the IAN 222 when implemented in wireless system infrastructure, and Bluetooth or wireless USB may be used for the IAN 222 when implemented in mobiles. The IAN 222 may operate to combine multiple antennas for receiving. Furthermore, the present systems and methods may fine-tune the use of transmit antennas based upon receiver locations and characteristics. The IAN 222 may be used to share fully received packets, receive samples that no individual receiver could decode, and spread outbound packets to RF transmitters. Time, space, and possibly frequency diversity may be increased, thus improving ability to overcome RF impairments, e.g., line of sight obstacles.

The distributed base station 212 may communicate with a base station controller (BSC) 224 (also referred to as a radio network controller or packet control function). The base station controller 224 may communicate with a mobile switching center (MSC) 226, a packet data serving node (PDSN) 228 or internetworking function (IWF), a public switched telephone network (PSTN) 230 (typically a telephone company), and an Internet Protocol (IP) network 232 (typically the Internet). The mobile switching center 226 may be responsible for managing the communication between a mobile station 204 and the public switched telephone network 230 while the packet data serving node 228 may be responsible for routing packets between the mobile stations 204 and the IP network 232. The fully received packets and spectral samples may be collected via the IAN 222 by the RX processing node 216 that combines them into the final received data. The TX processing node 218 may select transmitters and send data and transmission parameters to the transmitters. The infrastructure version may use multiple antennas perhaps 10 to 100 meters apart. The IAN 222 may combine receivers and transmitters in a general vicinity, such as the rooftop of a building. On the reverse link (RL) infrastructure receive side, single receivers may fully decode and share most of the RL packets received. This may help to reduce the load on the IAN 222 and focus processing power on the task of recovering packets that no individual receiver could receive. This remaining recovery may be performed by baseband correlation, summation, and decoding so that these packets may still be received. The mobile device version may use a PAN to combine receive and transmit antennas from multiple devices carried by a single user or within proximity of the user. Mobile stations 204 may not have the computational or communications capacity to perform baseband signal correlation, summation, and decoding since the power required to use this technique may be excessive. Therefore, the implementations in the infrastructure versus the mobile devices may vary according to device capabilities.

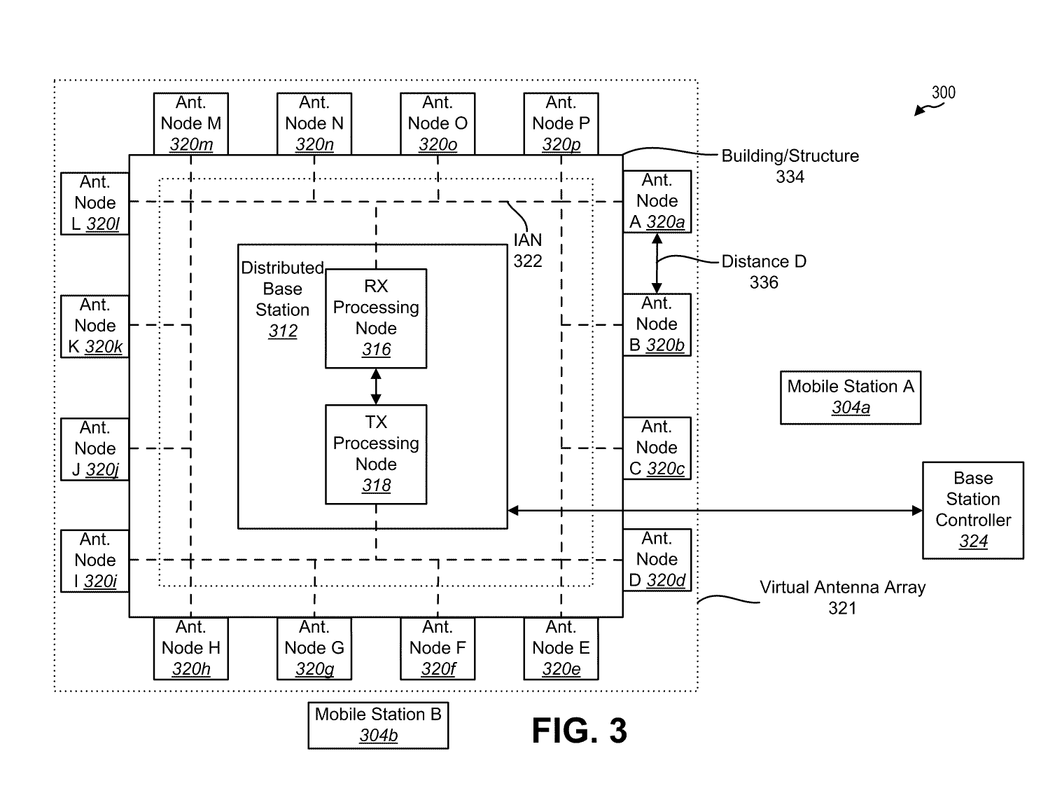

FIG. 3 is a block diagram of a system 300 implementing a distributed base station 312. Specifically, FIG. 3 illustrates the modules in one possible configuration of a distributed base station 312. The illustrated configuration may be particularly well suited for small cell infrastructure applications that cover areas that have multiple obstructions (such as buildings and trees) that impair RF signals for particular antennas but not likely for all at once.

Multiple antenna nodes 320 (antenna node A 320a through antenna node P 320p combine to form a virtual antenna array 321) may be inexpensively hosted on top of a building/structure 334 and connected by inexpensive, readily available local area network (LAN) components to form a packet-based IAN 322. While the illustrated configuration includes sixteen antenna nodes 320, the present systems and methods scale easily from a few to many antennas. By communicating at the packet level, the distributed base station 312 may be cheaper and easier to implement, i.e., off-the-shelf components may be less expensive and have broader compatibility than custom components. Buildings/structures 334 may be advantageously used as radio frequency obstacles to increase capacity and bandwidth by surrounding service areas with antenna nodes 320 and using the building/structure 334 to separate the service areas. As before, the distributed base station 312 may include an RX processing node 316 and a TX processing node 318. The RX processing node 316 and the TX processing node 318 may be housed in a utility closet or another suitable location as long as they are connected to the IAN 322. Furthermore, the RX processing node 316 and the TX processing node 318 may be housed in the same device or in separate devices. The distributed base station 312 may communicate with a base station controller 324 that manages one or more base stations 102a-b and/or distributed base stations 312.

The RX processing node 316 may receive packets from the antenna nodes 320, and when required, attempt to recover packets if none of the individual antenna nodes 320 receive a complete packet, e.g., none of the received packets pass the CRC. This recovery may include signal combining on the reverse link receive side and may be done by sharing a mixture of fully received packets and correlation, summing, and decoding RF bandwidth samples in cases in which packets should be present but are not being detected by any of the individual antenna nodes 320.

The TX processing node 318 may be used to selectively transmit packets from the distributed base station 312 to a mobile station 304. In one configuration, the forward link transmissions from the antenna nodes 320 may not transmit the exact same signal as each other, e.g., some antenna nodes 320 may not be used to transmit and some antenna nodes 320 may use different transmit power based on quality feedback data about the quality of each antenna node's 320 link with the mobile station 304.

In order to provide better space diversity, the distance D 336 between the antenna nodes 320 may be relatively large, e.g., 10 to 100 meters. This may limit the possibility of having all active antenna nodes 320 obstructed at the same time. For example, if an obstruction was introduced between mobile station A 304a and antenna node A 320a, it is unlikely that, with a large distance D 336, the obstruction would also affect communication with antenna node B 320b, antenna node C 320c, and antenna node D 320d. Likewise, if an obstruction was introduced between mobile station B 304b and antenna node E 320e, it is unlikely that, with a large distance D 336, the obstruction would also affect communication with antenna node F 320f, antenna node G 320g, and antenna node H 320h. The distance between the antenna nodes 320 may be different. For example, the distance between antenna node I 320i and antenna node J 320j may be different than the distance between antenna node K 320k and antenna node L 3201.

By using many distantly spaced antenna nodes 320, the present systems and methods may improve fault resiliency since the virtual antenna array 321 may fall back to fewer antennas if an antenna node 320 is damaged. Furthermore, this configuration may allow lower transmit power levels. Specifically, some infrastructure antenna nodes 320 may be given power and others not used to transmit. Conversely, the mobile stations 304 may use less transmit power because their signals will likely be received by many antenna nodes 320. This may reduce transmitter power drain on mobile stations 304. Since less interference may be generated for neighboring wireless links when transmit power is kept lower, data rates may also be increased. Furthermore, the “sectorization” of a service area by using a building/structure 324 may also increase capacity, allow fine-tuning of transmit power, and increase the probability of accurately receiving data. This may also reduce the need for bandwidth-consuming packet retransmissions and forward error correction (FEC).

The present systems and methods are not tied to one type of air link. For example, a single frequency network (SFN) may use multiple orthogonal frequency-division multiplexing (OFDM) transmitters, e.g., MediaFLO by Qualcomm Incorporated. Wideband OFDM subcarrier partitioning may also allow signals to be sent on wider bands at varying frequencies from multiple antennas to take advantage of varying frequency specific loss. 3G-style rake receiver technology may also be applicable, e.g., forward link signals as seen by mobile stations 304 may appear to be multipath versions of the same signal. Additionally, the antenna nodes 320 may use multiple input/multiple output (MIMO) technology. Combining the virtual antenna array with MIMO in the individual antenna nodes 320 may improve the overall system's ability to transmit and receive at high data rates with low power and low interference.

Some multiple-antenna solutions may perform all the processing at a central location, e.g., the antennas may simply transmit a received signal to processing hardware. In contrast, each antenna node 320 in the distributed base station 312 may demodulate, decode, and/or otherwise process the received signal to extract packet(s), i.e., the antenna nodes 320 may communicate with the RX processing node 316 and the TX processing node 318 at the packet level, not the received signal level. Thus, the present systems and methods may allow more flexibility in changing configuration of antennas such as adding or moving them to improve coverage as compared to the other multiple-antenna systems.

Other multiple-antenna technologies may not receive a communication signal, but rather monitor the sky. They do not receive packets. However, the present systems and methods focus on, among other things, how to keep the use of multiple distributed antenna nodes 320 cheap and reliable while improving the receive side reliability independently of the transmit side. The present systems and methods may also use digital signal transport, (i.e., the antenna nodes 320 communicate at the packet level), and the forward link transmissions from the antenna nodes 320 may not transmit the exact same signal as each other. Furthermore, the signal combining on the reverse link receive side may be done via sharing of a mixture of fully received packets and correlation, summing, and decoding RF bandwidth samples in cases in which packets should be present but are not being detected by any of the individual receivers.

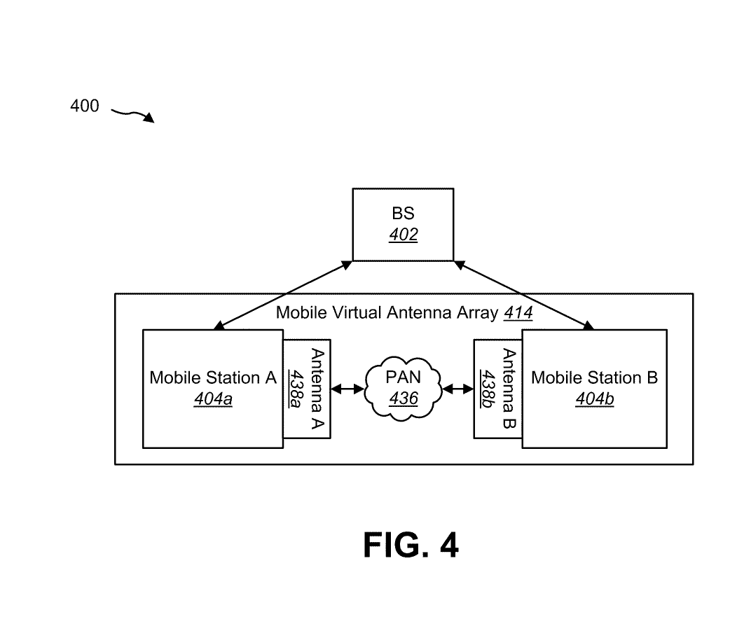

FIG. 4 is a block diagram illustrating a system 400 with a mobile virtual antenna array 414. When tuned for a lower bandwidth personal area network (PAN) 436 and power and computing resource limitations for mobile stations 404, the system 300 of FIG. 3 may also apply to a collection of multiple mobile stations 404. In other words, FIG. 3 illustrates an infrastructure implementation of the present systems and methods while FIG. 4 illustrates a mobile configuration. The mobile device version may use a PAN 436 to combine receive and transmit antennas 438 from multiple mobile stations 404 carried by a single user or within proximity of the user. However, this configuration may not have the computational, communications, or power capacity to perform baseband signal correlation, summation, and/or decoding.

The mobile virtual antenna array 414 may communicate with one or more standard base stations 402 and/or distributed base stations 312. The mobile virtual antenna array 414 may include a mobile station A 404a and a mobile station B 404b. For example, a user may have mobile station A 404a in a right-side pocket and mobile station B 404b in a left-side pocket. If mobile station A 404a is communicating with the base station 402, but the user is positioned with his left side toward the base station 402, thus creating an obstruction for mobile station A 404a, then mobile station A 404a may communicate with the base station 402 via mobile station B 404b using the PAN 436. In other words, the mobile virtual antenna array 414 may determine which mobile station 404 has the best communication link with the base station 402 and use the antenna 438 of that mobile station 404 to communicate, e.g., using antenna A 438a if mobile station A 404a has the highest quality link or using antenna B 438b if mobile station B 404b has the highest quality link. This may allow the mobile station(s) 404 to use less power when transmitting because the best link will be used. Signals received from the base station 402 may be passed to the intended mobile station 404 within the mobile virtual antenna array 414 when the communicating mobile station 404 is not the intended recipient.

The mobile virtual antenna array 414 may include more than two mobile stations and may cover a larger proximity than a person. For example, a navigation system, a smart phone, and a laptop in a car may form a mobile virtual antenna array 414.

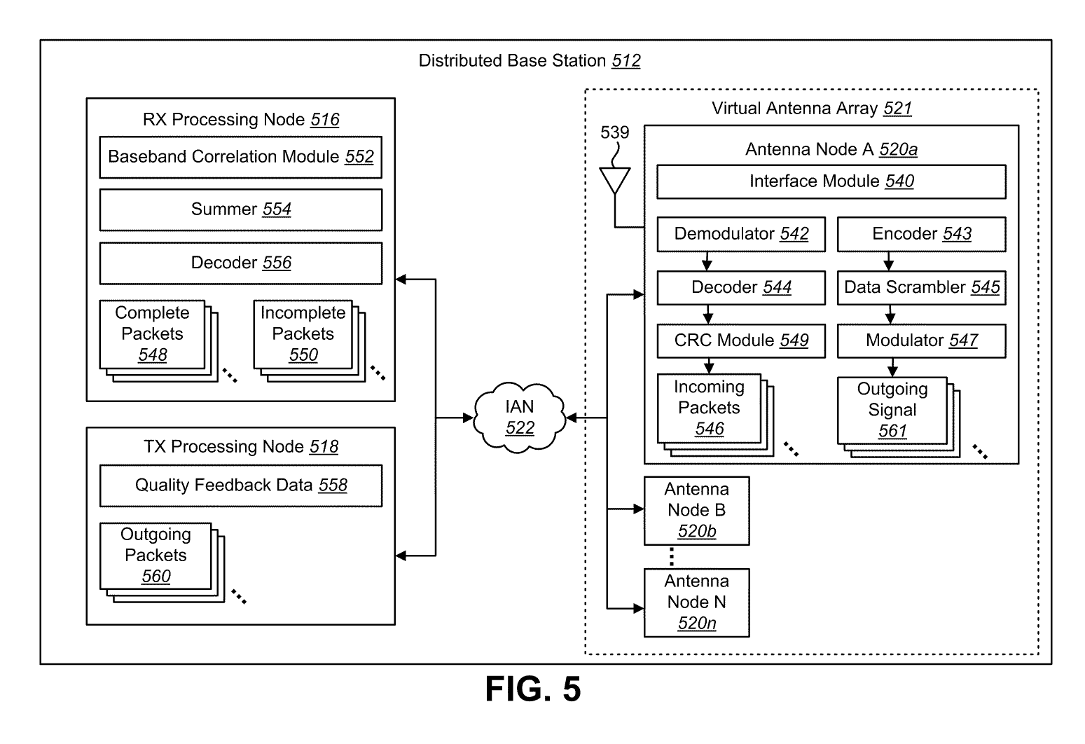

FIG. 5 is a block diagram illustrating a distributed base station 512. This may include N antenna nodes 520 that combine to form a virtual antenna array 521, i.e., antenna node A 520a, antenna node B 520b, and antenna node N 520n form the virtual antenna array node 521. Each antenna node 520 may include various components for communication and signal processing purposes. For example, the antenna nodes 520 may include an interface module 540 to interface with the packet-based IAN 522, e.g., a Gigabit Ethernet card. The antenna nodes 520 may also include a demodulator 542 to demodulate received symbols, a CRC module 549 to perform a cyclic redundancy check, and a decoder 544 to extract incoming packets 546 from incoming signals, e.g., reverse link packets. The antenna nodes 520 may also include other modules (not shown) for converting to and from the packet-level.

The incoming packets 546 may be sent to the RX processing node 516. If at least one of the incoming packets 546 is a complete packet 548, the distributed base station 512 may send the complete packet to a base station controller 324 and then to its destination. However, if the incoming packets 546 from all the antenna nodes 520 are incomplete packets 550, the RX processing node 516 may attempt to recover a complete packet 548 from the incomplete packets 550. Specifically, the RX processing node 516 may use a baseband correlation module 552 to perform baseband correlation, a summer 554 to perform summation, and a decoder 556 to decode the summed data into complete packets 548. This may include error correcting codes, e.g., convolutional codes, Reed-Soloman codes, Hamming codes, Turbo codes, low-density parity-check codes (LDPC), etc.

The distributed base station 512 may also include a TX processing node 518 that selectively transmits outgoing packets 560 (forward link packets) over the virtual antenna array 521. Specifically, the TX processing node 518 may use quality feedback data 558 to determine which antenna nodes 520 should be used to send outgoing packets 560 to a mobile station 304, e.g., forward link packets. The quality feedback data 558 may be any data that indicates the quality of one or more wireless communication links between one or more antenna nodes 520 and a particular mobile station 304. For example, the quality feedback data 558 may indicate that antenna node A 520a and antenna node B 520b currently have good communication links with a particular mobile station 304, but that antenna node N 520n does not have a good communication link with the mobile station 304. Using this data, the TX processing node 518 may determine that outgoing packets 560 intended for the mobile station 304 should be sent on antenna node A 520a and antenna node B 520b, but not antenna node N 520n. This may conserve power and eliminate unwanted interference on other wireless communication links, i.e., links to other mobile stations 304.

Therefore, the antenna nodes 520 may receive outgoing packets 560 from the TX processing node 518 and process the outgoing packets 560 into an outgoing signal 561. In other words, the antenna nodes 520 may include 520 an encoder 543, a data scrambler 545, and a modulator 547 to produce an outgoing signal 561. Furthermore, the antenna nodes 520 may include one or more antennas 539 to receive incoming signals and transmit outgoing signals 561.

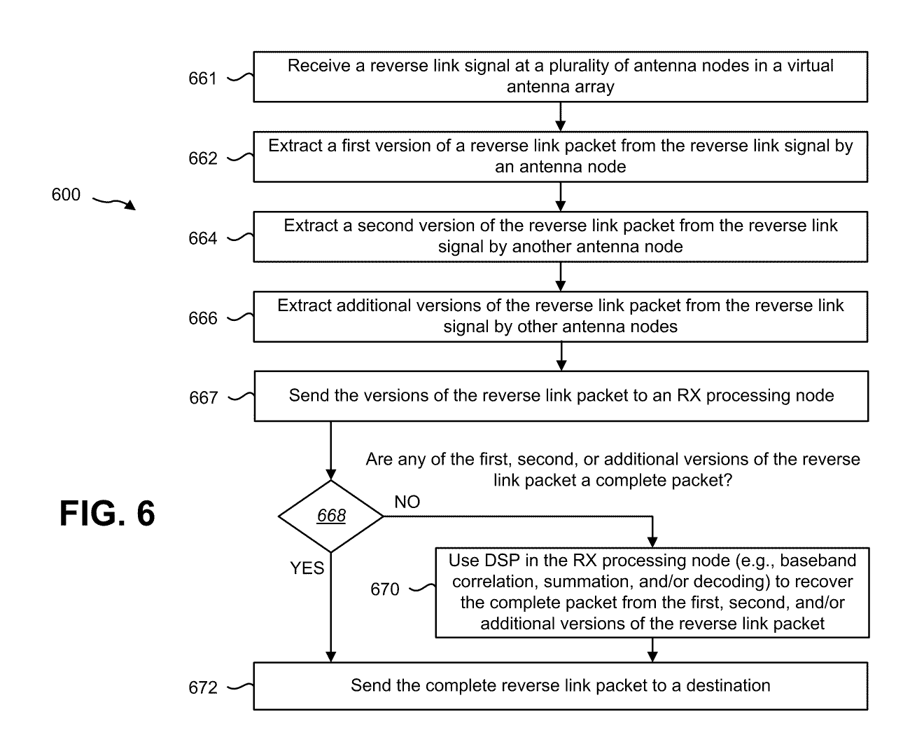

FIG. 6 is a flow diagram illustrating a method 600 for receiving data using a distributed base station 512. Specifically, FIG. 6 illustrates a method 600 for receiving when no single antenna node 520 receives a complete packet 548. Initially, the distributed base station 512 may receive 661a reverse link signal from a mobile station 304. One or more of the antenna nodes 520 in the virtual antenna array 521 may receive the reverse link signal. The distributed base station 512 may extract 662 a first version of a reverse link packet from the reverse link signal, e.g., antenna node A 520a may demodulate, decode, and/or otherwise process the reverse link signal to produce a reverse link packet 546. The distributed base station 512 may extract 664 a second version of the reverse link packet from the reverse link signal, e.g., antenna node B 520b may also produce a version of the same reverse link packet 546 through demodulation, decoding, etc. The distributed base station 512 may also extract 666 additional versions of the reverse link packet from the reverse link signal, e.g., antenna node N 520n may also produce a version of the same reverse link packet 546. The antenna nodes 520 may send 667 the versions of the reverse link packet to an RX processing node 516 in the distributed base station 512. The distributed base station 512 may then determine 668 whether any of the first version, second version, or additional versions of the incoming packet 546 (reverse link packet) are complete packets 548. This determination 668 may use any suitable method to determine if the received packet 546 includes bit errors, e.g., CRC, checksum, parity bit, or other hash functions. This determining 668 may be performed on the antenna nodes 520 or the RX processing node 516. If no versions of the reverse link packet 546 are complete, the RX processing node 516 may use 670 digital signal processing (DSP) to recover the complete packet 548 from the first, second, and/or additional versions of the reverse link packet 546. In other words, baseband correlation, summation, and decoding may be used to recover a complete packet 548 from two or more incomplete packets 550. If at least one of the versions of the reverse link packet 546 is complete, or following the DSP, the distributed base station 512 may send 672 the complete reverse link packet 548 to a destination, e.g., to a base station controller 224 that routes the packet to a packet data serving node 228 and then to the Internet 232.

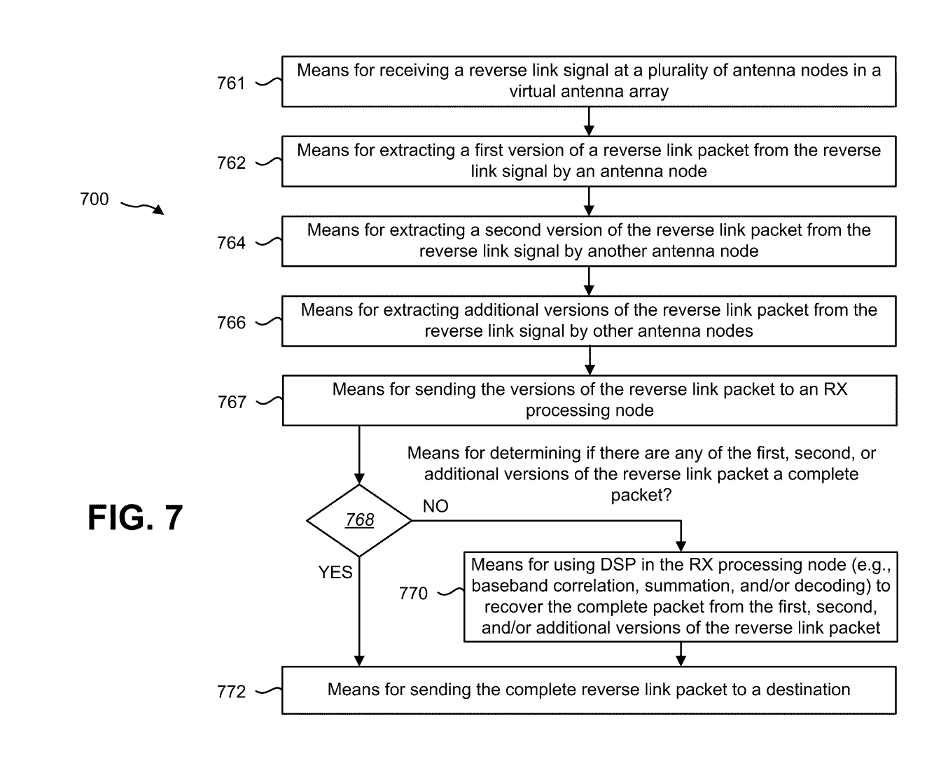

The method 600 of FIG. 6 described above may be performed by various hardware and/or software component(s) and/or module(s) corresponding to the means-plus-function blocks 700 illustrated in FIG. 7. In other words, blocks 661 through 672 illustrated in FIG. 6 correspond to means-plus-function blocks 761 through 772 illustrated in FIG. 7.

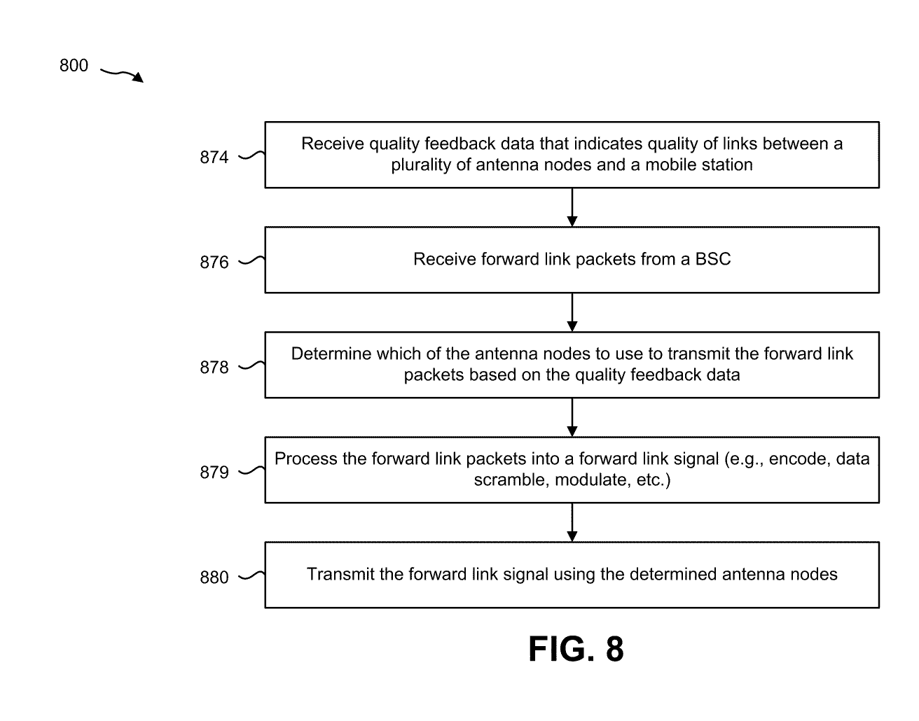

FIG. 8 is a flow diagram illustrating a method 800 for transmitting data using a distributed base station 512. A TX processing node 518 may receive 874 quality feedback data 558 that indicates quality of links between a plurality of antenna nodes 520 and a mobile station 204. The TX processing node 518 may also receive 876 forward link packets 560 from a base station controller 224. The forward link packets 560 may be intended for transmission to the mobile station 204. The TX processing node 518 may determine 878 which of the antenna nodes 520 to use to transmit the forward link packets 560 based on the quality feedback data 558. In other words, if a particular antenna node 520 is not receiving a signal from the mobile station 104a-m at a high quality, it may be unlikely that transmission on the same antenna node 520 will effectively reach the mobile station 204. For example, an acceptable quality level may be defined and/or adjusted by a user in terms of signal-to-noise ratio (SNR), error rate, or other suitable metric. Then, if data received at a particular antenna node 520 meets the quality level, the antenna node 520 may be used to transmit. The distributed base station 512 may process 879 the forward link packets 560 into a forward link signal 561 using one or more techniques, e.g., encoding, data scrambling, modulation, etc. The processing 879 may be performed by the TX processing node 518 or the antenna nodes 520. The distributed base station 512 may transmit 880 the forward link signal 561 using the determined antenna nodes 520. Therefore, in one configuration, only a subset of the antenna nodes 520 in the distributed base station 512 are used to transmit 880 and one or more antenna nodes 520 are silent.

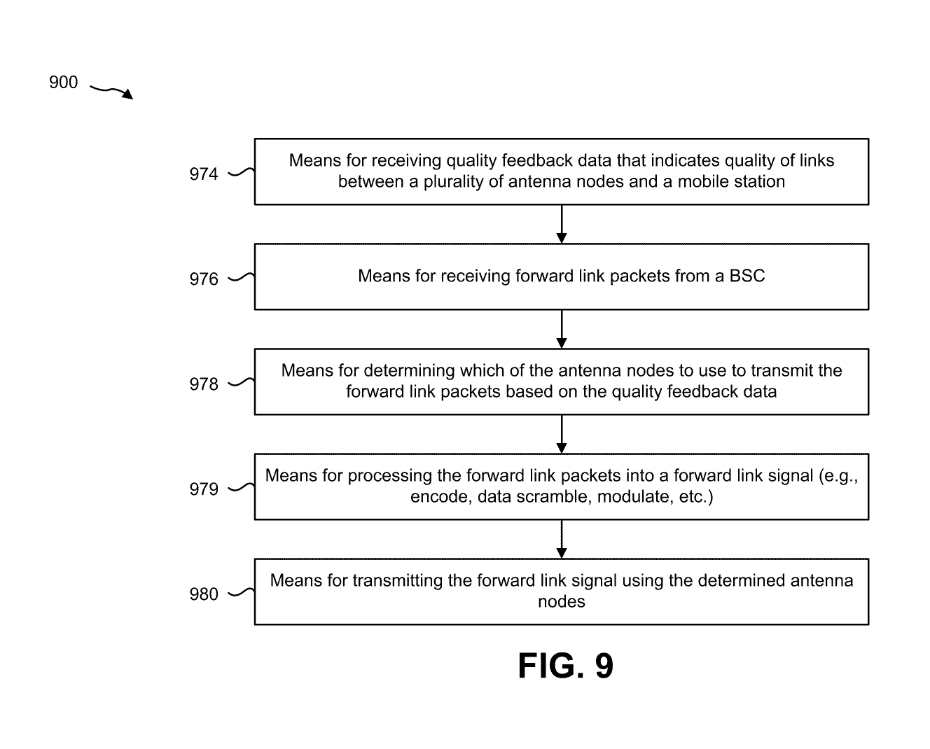

The method 800 of FIG. 8 described above may be performed by various hardware and/or software component(s) and/or module(s) corresponding to the means-plus-function blocks 900 illustrated in FIG. 9. In other words, blocks 874 through 880 illustrated in FIG. 8 correspond to means-plus-function blocks 974 through 980 illustrated in FIG. 9.

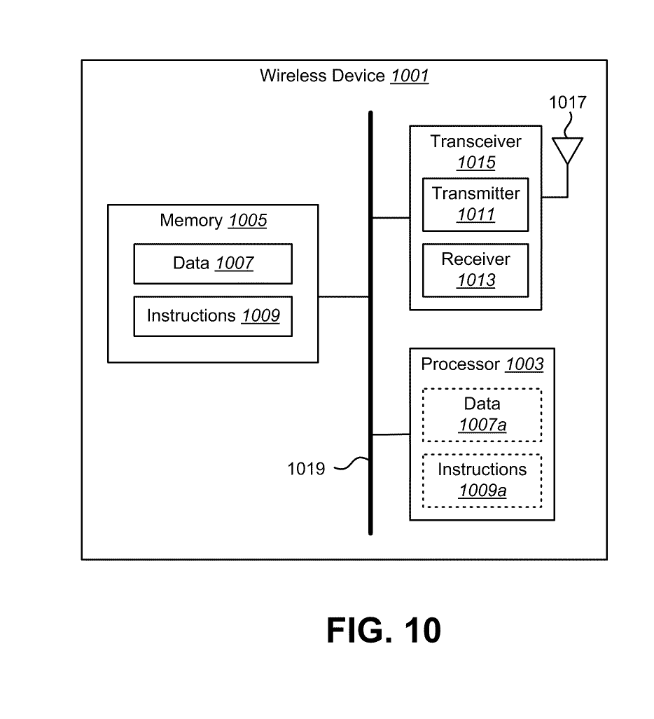

FIG. 10 illustrates certain components that may be included within a wireless device 1001. The wireless device 1001 may be a mobile station 104a-m, a base station 102a-b, a part of a mobile virtual antenna array 114, or a part of a distributed base station 112.

The wireless device 1001 includes a processor 1003. The processor 1003 may be a general purpose single- or multi-chip microprocessor (e.g., an ARM), a special purpose microprocessor (e.g., a digital signal processor (DSP)), a microcontroller, a programmable gate array, etc. The processor 1003 may be referred to as a central processing unit (CPU). Although just a single processor 1003 is shown in the wireless device 1001 of FIG. 10, in an alternative configuration, a combination of processors (e.g., an ARM and DSP) could be used.

The wireless device 1001 also includes memory 1005. The memory 1005 may be any electronic component capable of storing electronic information. The memory 1005 may be embodied as random access memory (RAM), read-only memory (ROM), magnetic disk storage media, optical storage media, flash memory devices in RAM, on-board memory included with the processor, EPROM memory, EEPROM memory, registers, and so forth, including combinations thereof.

Data 1007 and instructions 1009 may be stored in the memory 1005. The instructions 1009 may be executable by the processor 1003 to implement the methods disclosed herein. Executing the instructions 1009 may involve the use of the data 1007 that is stored in the memory 1005. Additionally, the instructions 1009a and data 1007a may be loaded onto the processor.

The wireless device 1001 may also include a transmitter 1011 and a receiver 1013 to allow transmission and reception of signals between the wireless device 1001 and a remote location. The transmitter 1011 and receiver 1013 may be collectively referred to as a transceiver 1015. An antenna 1017 may be electrically coupled to the transceiver 1015. The wireless device 1001 may also include (not shown) multiple transmitters, multiple receivers, multiple transceivers and/or multiple antenna.

The various components of the wireless device 1001 may be coupled together by one or more buses, which may include a power bus, a control signal bus, a status signal bus, a data bus, etc. For the sake of clarity, the various buses are illustrated in FIG. 10 as a bus system 1019.

The techniques described herein may be used for various communication systems, including communication systems that are based on an orthogonal multiplexing scheme. Examples of such communication systems include Orthogonal Frequency Division Multiple Access (OFDMA) systems, Single-Carrier Frequency Division Multiple Access (SC-FDMA) systems, and so forth. An OFDMA system utilizes orthogonal frequency division multiplexing (OFDM), which is a modulation technique that partitions the overall system bandwidth into multiple orthogonal sub-carriers. These sub-carriers may also be called tones, bins, etc. With OFDM, each sub-carrier may be independently modulated with data. An SC-FDMA system may utilize interleaved FDMA (IFDMA) to transmit on sub-carriers that are distributed across the system bandwidth, localized FDMA (LFDMA) to transmit on a block of adjacent sub-carriers, or enhanced FDMA (EFDMA) to transmit on multiple blocks of adjacent sub-carriers. In general, modulation symbols are sent in the frequency domain with OFDM and in the time domain with SC-FDMA.

In the above description, reference numbers have sometimes been used in connection with various terms. Where a term is used in connection with a reference number, this is meant to refer to a specific element that is shown in one or more of the Figures. Where a term is used without a reference number, this is meant to refer generally to the term.

The term “determining” encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

The phrase “based on” does not mean “based only on,” unless expressly specified otherwise. In other words, the phrase “based on” describes both “based only on” and “based at least on.”

The term “processor” should be interpreted broadly to encompass a general purpose processor, a central processing unit (CPU), a microprocessor, a digital signal processor (DSP), a controller, a microcontroller, a state machine, and so forth. Under some circumstances, a “processor” may refer to an application specific integrated circuit (ASIC), a programmable logic device (PLD), a field programmable gate array (FPGA), etc. The term “processor” may refer to a combination of processing devices, e.g., a combination of a DSP and a microprocessor, a plurality of microprocessors, one or more microprocessors in conjunction with a DSP core, or any other such configuration.

The term “memory” should be interpreted broadly to encompass any electronic component capable of storing electronic information. The term memory may refer to various types of processor-readable media such as random access memory (RAM), read-only memory (ROM), non-volatile random access memory (NVRAM), programmable read-only memory (PROM), erasable programmable read-only memory (EPROM), electrically erasable PROM (EEPROM), flash memory, magnetic or optical data storage, registers, etc. Memory is said to be in electronic communication with a processor if the processor can read information from and/or write information to the memory. Memory that is integral to a processor is in electronic communication with the processor.

The terms “instructions” and “code” should be interpreted broadly to include any type of computer-readable statement(s). For example, the terms “instructions” and “code” may refer to one or more programs, routines, sub-routines, functions, procedures, etc. “Instructions” and “code” may comprise a single computer-readable statement or many computer-readable statements.

The functions described herein may be implemented in hardware, software, firmware, or any combination thereof. If implemented in software, the functions may be stored as one or more instructions on a computer-readable medium. The term “computer-readable medium” or “computer-program product” refers to any available medium that can be accessed by a computer. By way of example, and not limitation, a computer-readable medium may comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), floppy disk and Blu-ray® disc where disks usually reproduce data magnetically, while discs reproduce data optically with lasers.

Software or instructions may also be transmitted over a transmission medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of transmission medium.

The methods disclosed herein comprise one or more steps or actions for achieving the described method. The method steps and/or actions may be interchanged with one another without departing from the scope of the claims. In other words, unless a specific order of steps or actions is required for proper operation of the method that is being described, the order and/or use of specific steps and/or actions may be modified without departing from the scope of the claims.

Further, it should be appreciated that modules and/or other appropriate means for performing the methods and techniques described herein, such as those illustrated by FIG. 6-9, can be downloaded and/or otherwise obtained by a device. For example, a device may be coupled to a server to facilitate the transfer of means for performing the methods described herein. Alternatively, various methods described herein can be provided via a storage means (e.g., random access memory (RAM), read-only memory (ROM), a physical storage medium such as a compact disc (CD) or floppy disk, etc.), such that a device may obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the systems, methods, and apparatus described herein without departing from the scope of the claims.

What is claimed is:

1. A system for wireless communication, comprising:
a plurality of antenna nodes, wherein the antenna nodes are configured to receive an incoming signal, extract versions of an incoming packet from the incoming signal, and send the versions on a packet-based network;
a receive processing node, wherein the receive processing node is configured to receive the versions of the incoming packet from the antenna nodes, determine if any of the versions are complete packets, and recover a complete version of the reverse link packet based on the versions if none of the versions is complete; and
a transmit processing node, wherein the transmit processing node is configured to transmit an outgoing packet on one or more of the antenna nodes based on quality feedback data.

2. The system of claim 1, wherein the antenna nodes are placed between ten and 100 meters apart from each other.

3. The system of claim 1, wherein the quality feedback data indicates a quality of one or more wireless communication links between one or more of the antenna nodes and a mobile station.

4. The system of claim 1, wherein the transmit processing node is further configured to transmit the outgoing packet using only a subset of the antenna nodes and not at least one of the antenna nodes.

5. The system of claim 1, wherein the receive processing node is further configured to recover the complete version of the incoming packet using baseband correlation, summation, and decoding if none of the versions is complete.

6. The system of claim 1, wherein the packet-based network is an internet protocol (IP) local area network (LAN).

7. The system of claim 1, wherein the receive processing node is further configured to determine if any of the versions are complete by using a cyclic redundancy check (CRC), a checksum, or a parity bit.

8. A method for wireless communication, comprising:
extracting versions of an incoming packet from a received incoming signal;
sending the versions to a receive processing node on a packet-based network;
determining if any of the versions are complete packets;
recovering a complete version of the incoming packet based on the versions if none of the versions is complete; and
transmitting an outgoing packet on one or more of a plurality of antenna nodes based on quality feedback data.

9. The method of claim 8, further comprising receiving the incoming signal using the antenna nodes that are placed between ten and 100 meters apart from each other.

10. The method of claim 9, wherein the quality feedback data indicates a quality of one or more wireless communication links between one or more of the antenna nodes and a mobile station.

11. The method of claim 8, wherein the transmitting comprises using only a subset of the antenna nodes and not at least one of the antenna nodes.

12. The method of claim 8, wherein the recovering comprises using baseband correlation, summation, and decoding.

13. The method of claim 8, wherein the packet-based network is an internet protocol (IP) local area network (LAN).

14. The method of claim 8, wherein the determining comprises using a cyclic redundancy check (CRC), a checksum, or a parity bit.

15. A system for wireless communication, comprising:
means for extracting versions of an incoming packet from a received incoming signal;
means for sending the versions to a receive processing node on a packet-based network;
means for determining if any of the versions are complete packets;
means for recovering a complete version of the incoming packet based on the versions if none of the versions is complete; and
means for transmitting an outgoing packet on one or more of a plurality of antenna nodes based on quality feedback data.

16. The system of claim 15, further comprising means for receiving the incoming signal using the antenna nodes that are placed between ten and 100 meters apart from each other.

17. The system of claim 16, wherein the quality feedback data indicates a quality of one or more wireless communication links between one or more of the antenna nodes and a mobile station.

18. The system of claim 15, wherein the means for transmitting comprises means for transmitting the outgoing packet using only a subset of the antenna nodes not at least one of the antenna nodes.

19. The system of claim 15, wherein the means for recovering comprises means for using baseband correlation, summation, and decoding.

20. The system of claim 15, wherein the packet-based network is an internet protocol (IP) local area network (LAN).

21. The system of claim 15, wherein the means for determining comprises means for using a cyclic redundancy check (CRC), a checksum, or a parity bit.

22. A computer-program product for wireless communication, the computer-program product comprising a computer-readable medium having instructions thereon, the instructions comprising:
code for extracting versions of an incoming packet from a received incoming signal;
code for sending the versions to a receive processing node on a packet-based network;
code for determining if any of the versions are complete packets;
code for recovering a complete version of the incoming packet based on the versions if none of the versions is complete; and
code for transmitting an outgoing packet on one or more of a plurality of antenna nodes based on quality feedback data.

23. The computer-program product of claim 22, wherein the instructions further comprise code for receiving the incoming signal using the antenna nodes that are placed between ten and 100 meters apart from each other.

24. The computer-program product of claim 23, wherein the quality feedback data indicates a quality of one or more wireless communication links between one or more of the antenna nodes and a mobile station.

25. The computer-program product of claim 22, wherein the code for transmitting comprises code for transmitting the outgoing packet using only a subset of the antenna nodes, not at least one of the antenna nodes.
